(19) United States
(12) Patent Application Publication
(10) Pub. No.: US 2008/0047777 A1
(43) Pub. Date: Feb. 28, 2008

(54) CHEERING STICK

(76) Inventors: Wen-Kuan Chang, Taipei (TW); Te-Heng Hun, Taipei (TW); Chin-Hsiao Chen, Pusin Hsiang (TW)

Correspondence Address: Rabin & Berdo, P.C., Suite 500, 1101 14th Street, Washington, DC, 20005, US

(21) Appl. No.: 11/736,104

(22) Filed: Apr. 17, 2007

(30) Foreign Application Priority Data
Jun. 30, 2006 (TW) 095211494

(51) Int. Cl. G10K 11/00

(52) U.S. Cl. 181/5

(57) ABSTRACT

A cheering stick has a base and a sound maker. The base has a narrow segment held and blown by a user, a broad segment having a sidewall with a through hole. The sound maker is mounted in the through hole and has an outer end with an outer opening, an inner space and an annular partition. The outer opening has a membrane covering the outer opening. The annular partition is mounted in the inner space of the sound maker, separates the inner space into an outside space communicating with the narrow segment and an inside space communicating with the broad segment and has a distal end contacting the membrane of the outer end. Thus, when air from the narrow segment enters the inside space via the outside space, the membrane will vibrate to make sound.

### BACKGROUND OF THE INVENTION

1. Field of Invention

The present invention relates to a cheering stick, and more particularly to a cheering stick that can make sound by blown and knocked.

2. Description of the Related Art

Generally, a cheering stick is used in sport competition, such as baseball field, so a user can knock two cheering sticks to make sound to cheer a favor team. Furthermore, the user may use an air siren to make sound to increase a competitive ambiance. However, a conventional air siren usually comprises fuel gas that will contaminate environment. Additionally, when the fuel gas is run out, the conventional air siren will be disposed to pollute environment.

Although a present air siren use a gas that will not contaminate environment, which can be used repeatedly, the cheering stick and the air siren are separated elements. Thus, when the user holds two cheering sticks, he/she can not hold the air siren at a same time.

With reference to FIG. 4, a conventional cheering stick that can make sound by knocking and blowing has a hollow base (30) and a mouthpiece (40).

The base (30) has a narrow segment (31), a broad segment (32) and a shrunken segment (33).

The narrow segment (31) may be held by a user and has a narrow opening, an inner space, a sidewall and an annular partition (35). The narrow opening has a rubber membrane (34) to cover the narrow opening. The sidewall has an inner surface, an outer surface and a through hole (38). The annular partition (35) is mounted in the inner space to separate the inner space into an outside space (36) and an inside space (37) and has an upper edge and a lower edge. The upper edge contacts the rubber membrane (34). The lower edge connects to the inner surface of the sidewall of the narrow segment (31).

The broad segment (32) has a broad opening.

The shrunken segment (33) is formed between the narrow segment (31) and the broad segment (32) and communicates with the inside space (36) of the narrow segment (32).

The mouthpiece (40) is mounted on the outer surface of the sidewall of the narrow segment (31) near the shrunken segment (33) and communicates with the through hole (38) and the outside space (37). The mouthpiece (40) can be blown to allow air to flow into the outside space (37) and to vibrate the rubber membrane (34), so the air can enter the inside space (36). Thus, when the rubber membrane (34) vibrates, the cheering stick (30) will make sound. Therefore, the cheering stick can be knocked to make sound and also can be blown to make sound.

However, the mouthpiece (40) is mounted on the outer surface of the sidewall of the narrow segment, so the user can not hold tight and comfortably the conventional cheering stick.

To overcome the shortcomings, the present invention provides a cheering stick to mitigate or obviate the aforementioned.

### SUMMARY OF THE INVENTION

The primary objective of the present invention is to provide a cheering stick that can make sound by blown and knocked.

To achieve the objective, the cheering stick in accordance with the present invention has a base and a sound maker. The base has a narrow segment and a broad segment. The narrow segment is held and blown by a user. The broad segment has a sidewall with a through hole. The sound maker is mounted in the through hole and has an outer end, an inner space, a sidewall and an annular partition. The outer end has an outer opening and a membrane. The membrane covers the outer opening. The sidewall has an inlet. The annular partition is mounted in the inner space of the sound maker, separates the inner space into an outside space and an inside space and has a distal end. The outside space communicates with the narrow segment by the inlet. The inside space communicates with the broad segment. The distal end contacts the membrane of the outer end. Thus, when the air from the narrow segment enters the inside space via the outside space, the membrane will vibrate to make sound. Therefore, the cheering stick can be knocked to make sound and also can be blown to make sound. Furthermore, the sound maker is mounted in the broad segment, so the user can hold the narrow segment tight and comfortably.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a cheering stick in accordance with the present invention;

FIG. 2 is a cross sectional side view of the cheering stick in FIG. 1;

FIG. 3 is an exploded perspective view of the cheering stick in FIG. 1; and

FIG. 4 is a cross sectional side view of a conventional cheering stick of the prior art.

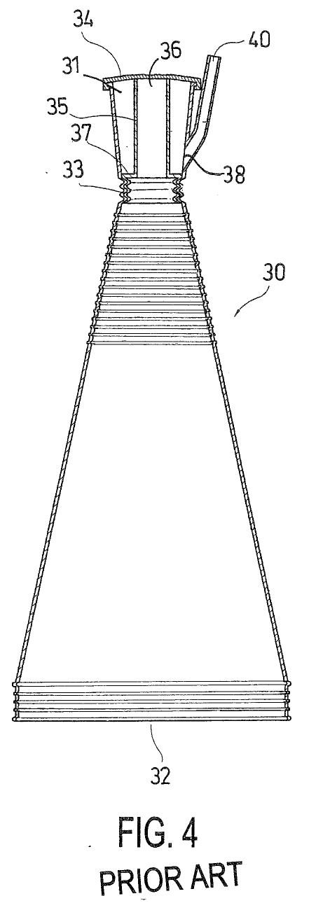

### DETAILED DESCRIPTION OF THE INVENTION

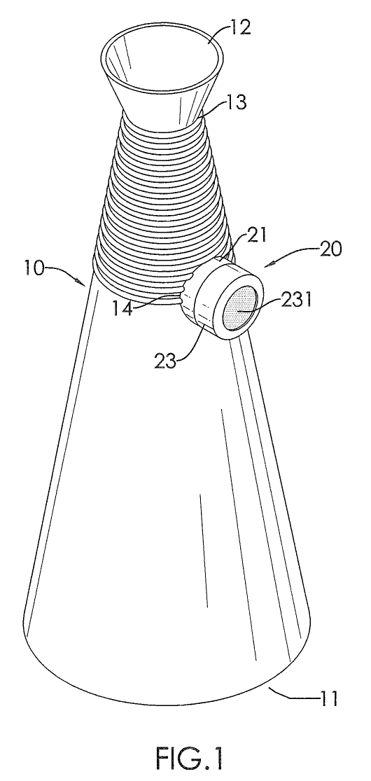

With reference to FIG. 1, the cheering stick in accordance with the present invention has a base (10) and a sound maker (20).

The base (10) is hollow and has a narrow segment (12), a broad segment (11) and a shrunken segment (13).

The narrow segment (12) may be held by a user and has a narrow opening. The narrow opening allows a user to blow air into the cheering stick.

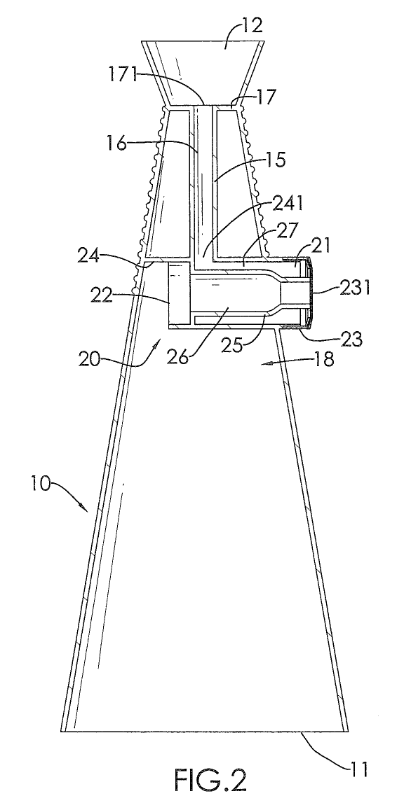

With further reference to FIG. 2, the broad segment (11) has a broad opening, an inner space (18) and a sidewall. The sidewall has a through hole (14) defined through the sidewall.

The shrunken segment (13) is mounted between the narrow segment (12) and the broad segment (11), is easy for the user to hold the cheering stick and has a partition (17). The partition (17) has a hole (171) and a tube (15). The hole (171) is defined through the partition (17) and allows the air that is entered from the narrow segment (12) to flow into the inner space of the broad segment (11). The tube (15) is mounted around the hole (171) in the partition (17), communicates with the inner space of the narrow segment (12), extends toward the inner space (18) of the broad segment (11) and has an air channel (16) defined through the tube (15) to concentrate the air from the narrow segment (12).

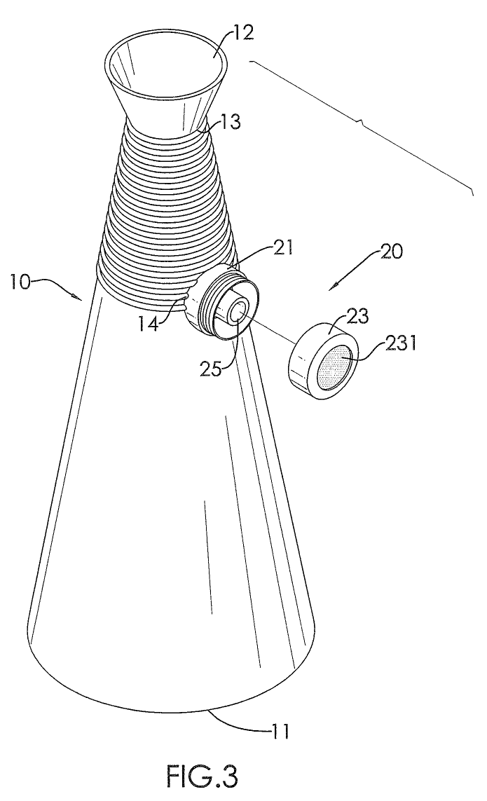

With further reference to FIG. 3, the sound maker (20) is tube-shaped, is mounted in the through hole (14) of the broad segment (11) and has an inner end, an outer end (21), an inner space, a sidewall (24) and an annular partition (25).

The inner end has an inner opening (22).

The outer end (21) may comprise a detachable cover (23). The detachable cover (23) is screwed to the outer end (21). The outer end (21) has an outer opening and a membrane (231). The outer opening is defined through outer end (21) and may be defined through the cover (23). The membrane (231) covers the outer opening and can be made of various materials and with various thicknesses to allow the sound maker (20) to generate sound with different frequency. When the membrane (231) with different materials or thicknesses are mounted respectively on multiple detachable covers (23), the user can choose one of the detachable cover (23) to screw to the outer end (21) to allow the sound maker (20) to generate sound with different frequency.

The sidewall (24) near the inner end is elongated to connect to the sidewall of the broad segment (11) and to fasten the sound maker (20). The sidewall (24) has an inlet (241). The inlet (241) is defined through the sidewall (24) of the sound maker (20) and allows the air from the narrow segment (12) to flow into the sound maker (20).

The annular partition (25) is mounted in the inner space of the sound maker (20), separates the inner space into an outside space (27) and an inside space (26) and has a proximal end and a distal end. The outside space (27) communicates with the inner space of the narrow segment (12) by the inlet (241) and may communicate with the air channel (16). The inside space (26) communicates with the inner space of the broad segment (12) by the inner opening (22). The proximal end is formed near the inner end of the sound maker (20) and connects to the sidewall (24) of the sound maker (20) to fasten the annular partition (25). The distal end contacts the membrane (231) of the outer end (21). Thus, when the air from the narrow segment (12) enters the inside space (26) of the sound maker (20) via the outside space (27), the membrane (231) will vibrate to make sound.

Therefore, the cheering stick can be knocked to make sound and also can be blown to make sound. Furthermore, the sound maker is mounted in the broad segment (11), so the user can hold the narrow segment (12) tight and comfortably.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A cheering stick having
a base being hollow and having
a narrow segment having a narrow opening; and
a broad segment having
a broad opening;
an inner space; and
a sidewall having a through hole defined through the sidewall; and
a sound maker mounted in the through hole of the broad segment and having
an inner end having an inner opening;
an outer end having
an outer opening defined through outer end; and
a membrane covering the outer opening;
an inner space;
a sidewall near the inner end being elongated to connect to the sidewall of the broad segment and to fasten the sound maker and the sidewall having an inlet defined through the sidewall of the sound maker; and
an annular partition mounted in the inner space of the sound maker, separating the inner space into an outside space communicating with the narrow segment and an inside space communicating with the broad segment and having
a proximal end formed near the inner end of the sound maker and connecting to the sidewall of the sound maker to fasten the annular partition; and
a distal end contacting the membrane of the outer end.

2. The cheering stick as claimed in claim 1, wherein a shrunken segment is mounted between the narrow segment and the broad segment and has a partition having
a hole defined through the partition and communicating with the inner space of the narrow segment and the inner space of the broad segment; and
a tube mounted around the hole in the partition, communicating with the inner space of the narrow segment and the inner space of the broad segment, extending toward the inner space of the broad segment and having an air channel defined through the tube and allowing the outside space of the sound maker to communicate with the air channel by the inlet.

3. The cheering stick as claimed in claim 1, wherein an outer end of the sound maker comprises a detachable cover screwed to the outer end and the outer opening is defined through the cover.

4. The cheering stick as claimed in claim 1, wherein the sound maker is tube-shaped.
